(19) United States
(12) Patent Application Publication
(10) Pub. No.: US 2015/0092680 A1
(43) Pub. Date: Apr. 2, 2015

(54) Flexible Receiver Architecture for Multiple Component Carrier Aggregation in Down Link

(71) Applicant: Broadcom Corporation, Irvine, CA (US)

(72) Inventors: Masoud Kahrizi, Irvine, CA (US); Bernd Pregardier, Oceanside, CA (US)

(73) Assignee: Broadcom Corporation, Irvine, CA (US)

(21) Appl. No.: 14/087,269

(22) Filed: Nov. 22, 2013

Related U.S. Application Data
(60) Provisional application No. 61/884,879, filed on Sep. 30, 2013.

(51) Int. Cl. H04W 72/04

(52) U.S. Cl. CPC H04W 72/0453
USPC 370/329

(57) ABSTRACT

A technique to provide receiver processing of a plurality of component carrier signals that are received from one or more transmitting source by a terminal device, in which filtered component carrier signals are processed and aggregated in the terminal device. Two of the component carrier signals may be in a same frequency band grouping or two or more of the component carrier signals may be in a different band grouping. The receiver architecture allows for flexible processing of the component carrier signals by allocating the different bands into frequency band groupings to process the plurality of component carrier signals.

### CROSS REFERENCE TO RELATED APPLICATION

The present U.S. Utility Patent Application claims priority pursuant to 35 U.S.C. §119(e) to U.S. Provisional Patent Application No. 61/884,879, entitled, “ Flexible Receiver Architecture for Multiple Component Carrier Aggregation in Down Link,” filed Sep. 30, 2013, which is incorporated herein by reference in its entirety for all purposes.

### BACKGROUND

1. Technical Field

The embodiments of the present disclosure relate to wireless communications and, more particularly, to the transmission of multiple carrier signals in down link communications.

2. Description of Related Art

In the mobile communication area, various systems are being implemented throughout the world to increase the amount of voice and data traffic that can be carried over the air to wireless devices. These systems include universal mobile telecommunications system (UMTS), advanced mobile phone services (AMPS), digital AMPS, global system for mobile communications (GSM), code division multiple access (CDMA), local multi-point distribution systems (LMDS), multi-channel-multi-point distribution systems (MMDS), Enhanced Data rates for GSM Evolution (EDGE), General Packet Radio Service (GPRS), as well as others. One recent development is Long Term Evolution (LTE), which uses a standard developed under the 3^{rd} Generation Partnership Project (3GPP or 3G) and is marketed as 4G communications technology.

As more constraints are placed on mobile network operators to provide improved data throughput and quality of services, new techniques are constantly being sought to provide such improvements or new developments. Network operators are looking to offer more attractive and distinctive services to enhance the end user experience, while device (e.g. phone) manufacturers and chipset vendors are competing to create highly desirable mobile devices and applications. One way to achieve an increase in downstream data rates is to increase the bandwidth of the down link communication.

A new technique is currently being developed utilizing the LTE standard, in which the down link bandwidth is increased via so-called carrier aggregation. For example, Release 10 under the current LTE standard and in a move toward the LTE-Advanced standard, specifies that radio frequency (RF) carriers from one or multiple base stations (Node B) may be aggregated and jointly used for transmissions to/from a single terminal. That is, instead of a single RF carrier being transmitted from a node (such as a cell tower, Node B, etc.) to a mobile device, the new LTE standard allows multiple carriers from one or multiple nodes to be sent down link to a single terminal. Because the use of multiple carriers increases the bandwidth of the transmitted signal, down link data rates to a user terminal or user equipment (UE) may be increased.

However, in order to process a signal carrying multiple carriers, additional radio front-end circuitry and processing circuitry may be needed. In simplistic terms, to process an aggregation of N number of carriers, N radio circuitry would be used, which would significantly increase the number of components used in a mobile phone, as well as an increase in the power requirements for the added circuitry. The solution is to find a way in which a mobile device not only has the capability of receiving and processing multiple component carriers, but to do so efficiently so as not to over-burden the functionality or power requirements of the mobile device.

### BRIEF DESCRIPTION OF THE DRAWINGS

FIG. 1 shows a system diagram of an example wireless communication network connecting a number of different mobile devices to a transmitting node that transmits multiple component carrier signals in accordance with the present disclosure.

FIG. 2 shows a system block diagram of an example receiver for a wireless communication device that receives RF signals carrying multiple component carrier signals in accordance with the present disclosure.

FIG. 3 shows a circuit diagram of an example receiver front-end that processes three component carrier signals that may be received across a number of frequency bands over four frequency band groupings, in which four mixers are used with a respective frequency band grouping for a total of sixteen mixers in accordance with the present disclosure.

FIG. 4 shows a circuit diagram of an example receiver front-end that processes three component carrier signals that may be received across a number of frequency bands over four frequency band groupings, in which three mixers are used with a respective frequency band grouping for a total of twelve mixers in accordance with the present disclosure.

FIG. 5 shows a circuit diagram of an example receiver front-end that processes three component carrier signals that may be received across a number of frequency bands over four frequency band groupings, in which two mixers are used with a respective frequency band grouping for a total of eight mixers in accordance with the present disclosure.

FIG. 6 shows a circuit diagram of an example receiver front-end that processes three component carrier signals that may be received across a number of frequency bands over four frequency band groupings, in which a total of six mixers are used for the four frequency band groupings in accordance with the present disclosure.

FIG. 7 is an example graph showing primary, secondary and tertiary component carrier processing for the frequency band groupings for the circuits shown in FIGS. 3-6 in accordance with the present disclosure.

FIG. 8 shows two other amplifier configurations to receive an RF input from a filter and provide two output paths in accordance with the present disclosure.

### DETAILED DESCRIPTION

The embodiments described below may be practiced in a variety of communication networks that utilize wireless technology to communicate between a transmission source or sources and a receiving device utilizing one or more communication protocols to transfer voice, video, data and/or other types of information. The particular technology described below pertains to Long Term Evolution (LTE) or 4^{th} Generation (4G) communication standards as applied to telephone (for example, cellular) devices. However, other embodiments need not be limited to LTE or 4G. Thus, GSM/EDGE, CDMA, Wide-CDMA (W-CDMA), Time Division Synchronous CDMA (TD-CDMA) communication techniques are applicable for use with the described embodiments or other embodiments. The component carrier aggregation allows for applications of both Frequency Division Duplexing (FDD) and Time Division Duplexing (TDD) schemes.

In particular, the multiple component carrier aggregation described herein pertains to an advancement of LTE toward LTE-Advanced and as specified in Release 10 (or subsequent Releases for LTE), but various embodiments may be applicable to other standards or protocols as well. Also, the particular embodiments described herein address the processing of up to three component carriers that are aggregated in a signal to a receiving terminal, such as a User Terminal (UE) in a cellular network, but other embodiments may service more component carriers, as well as utilize various other receiving devices.

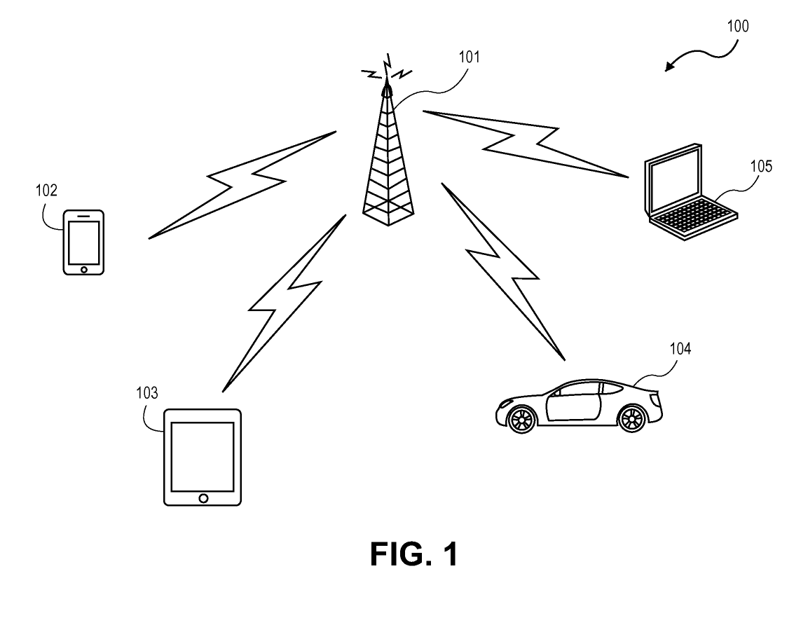

FIG. 1 shows a system diagram of an example wireless communication network connecting a number of different mobile devices to a transmitting node that transmits multiple component carrier signals. In FIG. 1, a system 100 is shown that includes a variety of receiving devices 102-105 configured to operate within a network having a down-link transmitting source 101. In the example system 100, transmitting source 101 is a cellular communication node, commonly referred to as a base station or Node B. However, transmitting source 101 need not be limited to cellular communication. Other embodiments may employ different communication technology from different wireless transmitting sources. Furthermore, instead of a single transmitting source 101, multiple transmitting sources 101 may be used for transmission of the multiple component carriers, wherein a respective one of the multiple transmitting sources transmits one or more component carrier(s) that comprise the aggregated signal sent to a receiver.

In the particular example for system 100, device 102 is a mobile phone (e.g. cell phone, smartphone, etc.), device 103 is a tablet computer with wireless phone capability, device 104 is a device affixed in a vehicle (e.g. a communication device or GPS navigation system with dual communication link), and device 105 is a notebook computer or a personal computer (PC) with wireless phone capability. It is to be noted that other types of devices may be present within system 100.

Devices 102-105, which are sometimes referred to as UEs, communicate with transmission source 101 utilizing one or more communication protocols and/or standards. As noted above, the network of system 100 may use LTE or 4G communication standard/protocol to transmit voice, audio, video, data, etc. from transmitting source 101 to receivers of devices 102-105. In particular, the transmitted signal from transmitting source 101 carries multiple component carrier signals that are aggregated and directed to one of the devices 102-105. Release 10 of the LTE standard permits up to five such component carrier signals to be aggregated. That is, from Release 10 onward, the transmission bandwidth may be extended by means of the so-called Carrier Aggregation (CA) technique, where multiple radio frequency (RF) carriers are aggregated and jointly, or substantially simultaneously, transmitted to a single terminal. This carrier aggregation increases the bandwidth to increase the down link data rate to a user at the receiving terminal. The receiver receiving the multiple component carrier signals processes the different component carrier signals separately and aggregates the processed components to recover the information contained in the multiple component carrier signals.

Thus, for system 100, the wireless link implements component carrier aggregation in transmitting an RF signal from source 101 (or a plurality of sources 101) to devices 102-105. In the description below, a scenario illustrates the use of up to three such component carrier signals that are aggregated. The transmitted signal from source(s) 101 to respective devices 102-105 may have one, two or three component carrier signals. Depending on the order of allocation in the network, the three component carriers are referred to as Primary Component Carrier (PCC), Secondary Component Carrier (SCC) and Tertiary Component Carrier (TCC). When only one component carrier is present, only the PCC is used. When two component carriers are present, the carriers are PCC and SCC. When all three are present, the carriers are PCC, SCC and TCC.

Although a single transmitting source 101 is illustrated in FIG. 1, the component carrier signals may be transmitted from multiple transmitting sources. Accordingly, PCC may be transmitted from a first transmitting source, SCC from a second transmitting source and TCC from a third transmitting source Likewise, one component carrier may be transmitted from one transmitting source, while two others may be transmitted from a second transmitting source. Other combinations are possible for transmitting component carriers from multiple transmitting sources. For simplicity, the description below refers to a single transmitting source 101, however, it is understood that the different component carrier signal may be respectively transmitted from one or a plurality of transmitting sources.

Depending on the network, which may depend on the geographic location of the network, the various RF frequency bands and carrier frequency allocations for the network may differ. In some networks, the network frequency allocation allows for two or more carriers to be in the same range of frequencies allocated as a particular band (e.g. frequency band) so that the multiple component carriers reside within the same allocated band (intra-band), whereas in other applications, one or more carriers reside in different allocated frequency bands (inter-band).

When two or more component carriers are allocated within the same allocated frequency band, the CA may be contiguous or non-contiguous. In Contiguous Carrier Aggregation (CCA), component carriers are located in adjacent channels. For example, with two contiguous component carriers, a first channel having a bandwidth (BW) of 20 MHz may be combined with an adjacent channel (having 20 MHz BW) to effectively provide a super BW channel of 40 MHz. Non-Contiguous Carrier Aggregation (NCCA) uses carriers that are located in the same allocated band, but in non-adjacent channels.

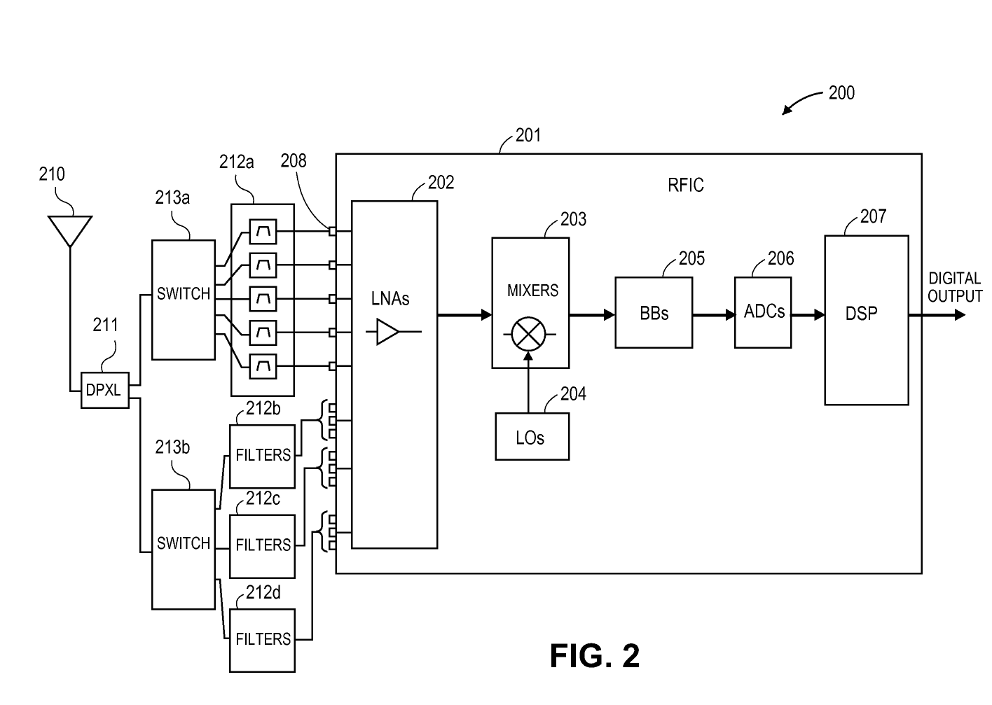

FIG. 2 shows a system block diagram of an example receiver for a wireless communication device that receives RF signals carrying multiple component carrier signal signals. In FIG. 2, a receiver 200 includes reception processing paths for a received signal carrying multiple component carriers. The particular receiver 200 may be included within one or more devices 102-105 of FIG. 1. Receiver 200 includes one or more antenna(s) 210 for coupling through one or more diplexer(s), one or more RF switches and/or one or more filtering modules/stages/network/assembly (referred herein simply as filter assembly or filters).

The particular example shown for receiver 200 has antenna 210 coupled to one side of a diplexer (DPXL) 211 and the other side of diplexer 211 has two connections, respectively coupled to RF switches 213a and 213b. Diplexer 211 splits the incoming RF signal from antenna 210 to switches 213a and 213b. Switch 213a switches the incoming RF signal to one or more filters of filter assembly 212a, while switch 213b switches the incoming RF signal to one or more filters of filter assembly 212b-212d. It is to be noted that the RF switches 213a-b may be replaced with a diplexer configuration based on simultaneous operation of certain bands and that the use of diplexers and switches, as well as the actual number of such diplexers and switches, may vary from embodiment to embodiment. Furthermore, the filters of filter assemblies 212a-d may be stand-alone filters or the filters could be a component part of the receiver, such as a filter portion of duplexers that support full duplex (FDD) operations for the radio transceiver. What is to be noted is that some filtering operation is performed to filter the incoming RF signal containing multiple component carrier signals and this filtering operation directs the component carriers into one or more separate input paths based on the frequency or frequency band.

It is also to be noted that diplexer 211 may be one diplexer or multiple diplexers to couple the incoming RF signal to a plurality of filters, where the input path may include one or more RF switches for switching the input to the filters. Although diplexers 211 and filter assemblies 212a-d are shown for the receiver, the same (or equivalent) components may be included for use with the transmission side of a transceiver, wherein the filters may operate as part of a duplexer to multiplex the outgoing and incoming signals to/from antenna 210. Note that the transmission path is not shown in FIG. 2, but wireless devices generally provide a transceiver that has both transmission and reception capabilities Likewise, RFIC 201 generally includes a transmitter side as well to accommodate both transmission and reception of RF signals.

It is to be further noted that a variety of radio front-ends may be used, instead of the example shown in FIG. 2. Various switches, diplexers, duplexers, wave guides, transmission lines, etc. may be used at the radio front-end. Likewise, the radio front-end may employ a variety of filters. In one embodiment, the radio front-end uses Surface Acoustic Wave (SAW) filters to designate a pass band to pass a selected range of frequencies through the respective filters. The filters may also provide for a particular implementation based on network usage or requirements. For example, the component carriers may all have the same bandwidth, or different bands or channels may have different bandwidths. In one application, the component carriers being transmitted may have a bandwidth of 1.4, 3, 5, 10, 15 or 20 MHz per carrier. Depending on the particular usage, a receiving device utilizes filters to accommodate not only the transmitted frequency (or frequency band), but also the allocated bandwidth requirements for individual component carriers being utilized for the particular network.

In the particular receiver 200, a respective one of the filters is designed to filter carriers that fall within a certain frequency range (e.g. filter bands) and the filters are further grouped into filter groupings to provide respective frequency band groupings (e.g. grouping of frequency bands), as noted by filter groupings of filter assemblies 212a-d. It is to be noted that the filter groupings may coincide with an allocated frequency spectrum for a given network or the grouping of the filters may be independent of such standard based frequency spectrum allocations.

RFIC 201 generally includes a Low Noise Amplifier (LNA) module or assembly (module/assembly) 202, mixer module/assembly 203, a local oscillator (LO) module/assembly 204, baseband (BB) module/assembly 205, Analog-to-Digital Converter (ADC) module/assembly 206, and some form of digital signal processing module/assembly 207. RFIC 201 is shown as a direct conversion receiver, but other embodiments may implement a heterodyne receiver where down-conversion of the incoming RF signal to baseband is done in multiple steps. The LNAs of LNA module/assembly 202 amplify the RF input signal from the filters and the mixer module/assembly 203 down-converts the inbound RF signal to baseband, based on a local oscillation signal provided by the LO module/assembly 204. The BB module/assembly 205 baseband processes the down-converted baseband signal and the ADC module/assembly 206 converts the baseband analog signal to an inbound digital signal. Digital signal processing module/assembly 207, typically using a digital signal processor (DSP), processes the digital signal to provide a digitally processed signal as an output from RFIC 201. The output signal from RFIC 201 may be coupled to modems, application processors, peripheral devices, host processors, etc. for whatever application the particular device does with incoming signals received by the device.

The one or more components of the radio front-end (e.g. filters, switches, diplexers, etc.) may also be included within RFIC 201. However, in a typical implementation, a chip vendor supplies the RFIC and the device manufacturer (e.g. phone OEM) designs the front-end for the device. Accordingly, the embodiment of FIG. 2 exemplifies this practice by showing the radio front-end prior to the LNAs as residing outside of the RFIC.

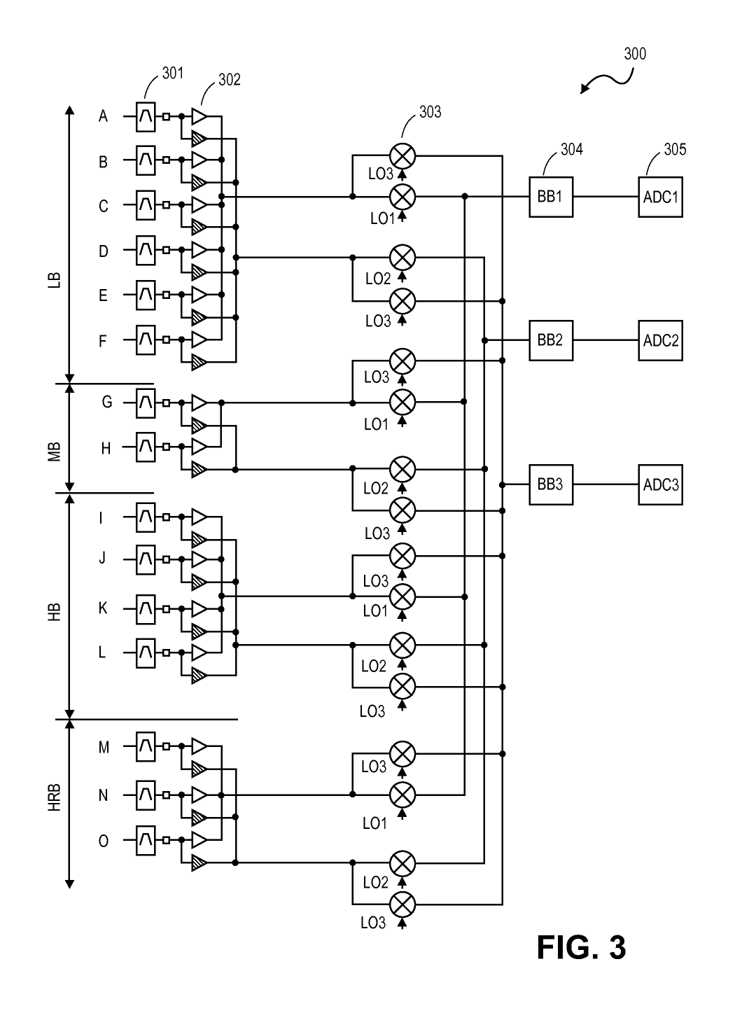

For a device to receive and process the multiple component carrier signals described above in a platform designed for a single carrier, it would be advantageous for the phone manufacturer to maintain the same radio front-end, provided that the allocated frequency spectrum and designated frequency bands do not change in the network. That is, the added capability for multiple component carrier signal processing for carrier aggregation may be designed into RFIC 201, so that a radio front-end of the device (in front of RFIC 201) designed for a single carrier platform could still be used. Accordingly, the embodiments shown in FIGS. 3-6 show embodiments for processing up to three component carrier signals, where the filters prior to the LNAs reside outside of RFIC 201.

FIG. 3 shows a circuit diagram of an example receiver front-end that processes three component carrier signal signals that may be received across a number of frequency bands over four frequency band groupings, in which four mixers are used with a respective frequency band grouping for a total of sixteen mixers. The number of frequency band groupings and the partitioning of such groupings depend on platform requirements and may be differently arranged then shown. In FIG. 3, a receiver 300 shows fifteen inputs to fifteen filters 301, in which the inputs are respectively noted as A-O. Receiver 300, except for the filters 301, may be included as part of RFIC 201 of FIG. 2, in which instance filters 301 are equivalent to filters 212a-d. Furthermore, filters 301 are grouped into the four frequency band groupings (or groups), designated as Low Band (LB), Mid-Band (MB), High Band (HB) and Higher Band (HRB). The filter grouping allocation shown is 6-2-4-3 for LB-MB-HB-HRB, to correspond to the inputs A-O. The frequency band groupings LB, MB, HB and HRB may be based on frequency spectrum allocation for a network, network standard, some other requirement or it may be arbitrary set. The frequency band grouping is not limited to four groupings and other embodiments may have less or more number of band groupings. What is to be noted is that filters of a particular band grouping pass signals of a selected frequency range (bandwidth) that fits within the designated spectrum set for that filter grouping.

For example, in one embodiment, the following frequency allocation is used:

| | | | |
|---|---|---|---|
| LB | 600-1000 | MHz | Inputs A-F |
| MB | 1400-2000 | MHz | Inputs G & H |
| HB | 1800-2200 | MHz | Inputs I-L |
| HRB | 2300-2600 | MHz | Inputs M-O |

Thus, for example, the six filters (shown having inputs A-F) of band grouping LB are configured to respectively pass different frequency bands that fit within 600-1000 MHz. Filters 301 may all have the same bandwidth characteristics or some (or all) may have different bandwidth characteristics. As noted above, the component carriers being transmitted may have a bandwidth of 1.4, 3, 5, 10, 15 or 20 MHz per carrier in one embodiment, so that the filter bandwidths may be selected based on these values. The actual number of filters 301 used per band grouping, as well as the band-pass setting for each filter, are design factors to allow for the filtering of the different carrier signal that are received by the receiver. Note that the number of filters shown in FIG. 3 is presented for exemplary purpose and actual devices may have the same, less or more such filters and filter arrangements.

A particular component carrier received at the antenna is filtered by one of the filters 301 based on its frequency. For inter-band carrier aggregation cases, three component carriers would be passed through three different filters based on the carrier frequencies. For any intra-band carrier aggregation cases, the intra-band carriers would be filtered through the same (common) filter. Respective filter outputs are coupled to a pair of LNAs 302, in which a filter output is coupled to a first set of LNAs (shown in lighter color) and also to a second set of LNAs (shown in darker color). This is done separately for each respective band grouping. The LNA outputs from the first set of LNAs for a particular band grouping are combined together and the outputs from the second set of LNAs for that particular band grouping are combined together. This is also done for the respective band groupings.

The first set of LNA outputs are coupled to a first mixer having a LO1 as the LO frequency and to a second mixer having LO3 as the LO frequency. The second set of LNA outputs are coupled to a third mixer having LO2 as the LO frequency and to a fourth mixer having LO3 as the LO frequency. This arrangement is also done for the respective filter band groupings. When only one carrier is received, only one mixer and one LO signal is used. When two component carriers are received, two mixers and two different LO signals are used. When three carriers are received, three mixers and three different LO signals are used.

The outputs from the mixers 303 are coupled to respective BB#304 for baseband processing and the outputs from the different BB# are then sent to respective ADC#305. The output of the ADC is in digital format and subsequently sent to a digital processor, such as DSP 207 of RFIC 201 shown in FIG.2.

A control mechanism is used to activate (or switch in) only one mixer per signal path, so that either LO1 or LO3 is used to down-convert the first set of LNA outputs and either LO2 or LO3 is used to down-convert the second set of LNA outputs. The outputs from mixers utilizing LO 1 are coupled to provide the down-converted output to BB1. The outputs from mixers utilizing LO2 are coupled to provide the down-converted output to BB2 and the outputs from mixers utilizing LO3 are coupled to provide the down-converted output to BB3. Those mixers 303 and BB#304 not being utilized for processing the received component carrier(s) may be made inactive.

Thus, the particular implementation of receiver 300 allows for three component carriers to be processed in the receiver, in which two of the component carriers may be intra-band carriers. With the two intra-band component carriers, the two intra-band component carriers would be both filtered by a common filter and then the filtered output provided to the two LNA input paths for that filter (a path for each of the two intra-band component carriers). A mixer corresponding to the one path down-converts the first filtered component carrier signal and a different mixer corresponding to the second path down-converts the second filtered component carrier signal. The third component carrier is in a different band grouping. Only two intra-band carriers are capable of being processed in a given band grouping due to the band groupings having two LNA paths.

It is to be noted that other embodiments may readily implement a third (or more) LNA path per RF input at each filter to provide for a third down-conversion path for a third (or more) carrier in the same frequency band grouping. However, such a third path may add considerable number of LNAs and mixers, as well as other components (e.g. control circuitry, switches, etc.), so that there may be a trade-off on whether it is desirable to process a third intra-band component carrier.

The embodiment of FIG. 3 provides flexibility to handle up to three component carrier signals by utilizing two input paths per RF input at the respective filters without overburdening the circuitry. The two LNA input signal paths per filter allows for two filtered component carrier signals to be processed, whether the two carrier signals are intra-band (passing through the same filter) or inter-band (passing through two different filters). Because the LNA outputs are combined only for a particular frequency band grouping, the third component carrier signal may be processed by a filter and one of the LNA input path of a different frequency band grouping. The number of substantially simultaneous component carrier signals that may be processed for a band grouping is dependent on the number of the LNA input paths per band grouping and the total number of the component carriers that may be aggregated is limited by the number of BBs available.

Accordingly, receiver 300 allows for the substantially simultaneous processing of up to three component carrier signals, in which:

all three component carriers are in different frequency band groupings (all inter-band);

two component carriers are in one frequency band grouping, but filtered using different filters, and the third component carrier is in a different frequency band grouping (all are inter-band); and

two component carriers are in one frequency band grouping and filtered using the same filter (intra-band), and the third component carrier is in a different frequency band grouping (inter-band).

It is to be noted that in some instances, where the two intra-band component carrier signals are contiguous (CCA), the same filter and the same LNA path may be capable of processing the two CCA carriers, since the two carriers' bandwidths are contiguous.

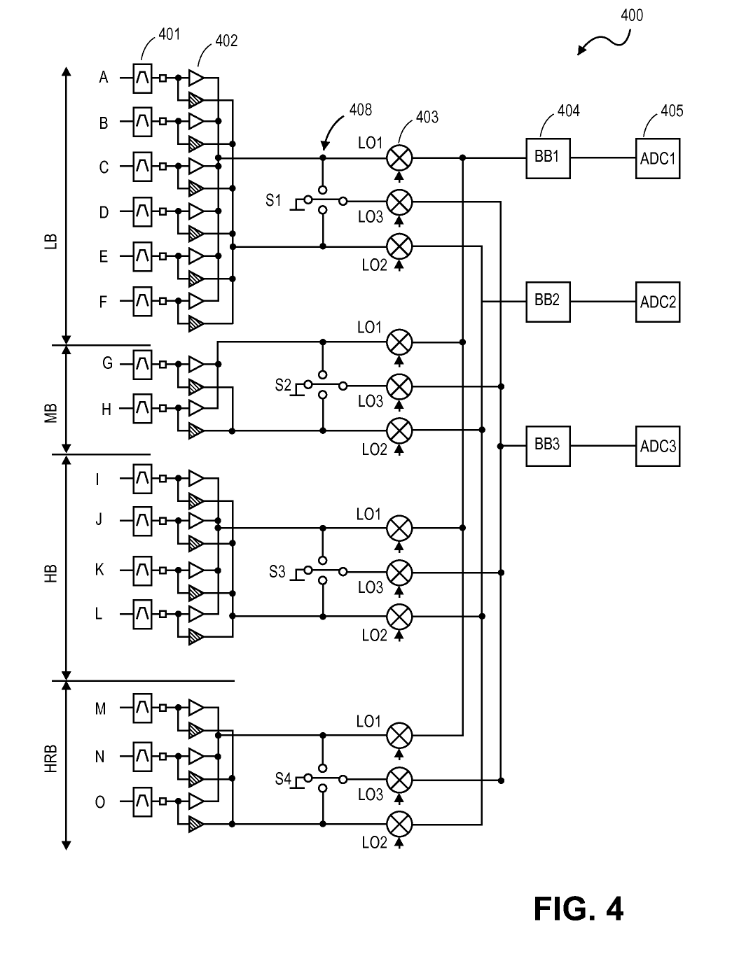

FIG. 4 shows a circuit diagram of an example receiver front-end that processes three component carrier signals that may be received across a number of frequency bands over four frequency band groupings, in which three mixers are used with a respective frequency band grouping for a total of twelve mixers. Receiver 400 of FIG. 4 is a variation of receiver 300 of FIG. 3, having similar combination of inputs A-O to filters 401 and LNAs 402. Instead of using two mixers per combined LNA output path per band grouping (or four mixers total for the band grouping), three mixers 403 are used for both combined LNA output paths per band grouping. Thus, instead of sixteen mixers, only twelve mixers are used. Switches 408 (S1-S4) switches a respective combined LNA output path between two LOs, so that the extra usage of the mixer using LO3 in FIG. 3 is removed from the embodiment of FIG. 4. The outputs of the mixers 403 are coupled to BBs 404 and ADCs 405, similar to the embodiment of FIG. 3.

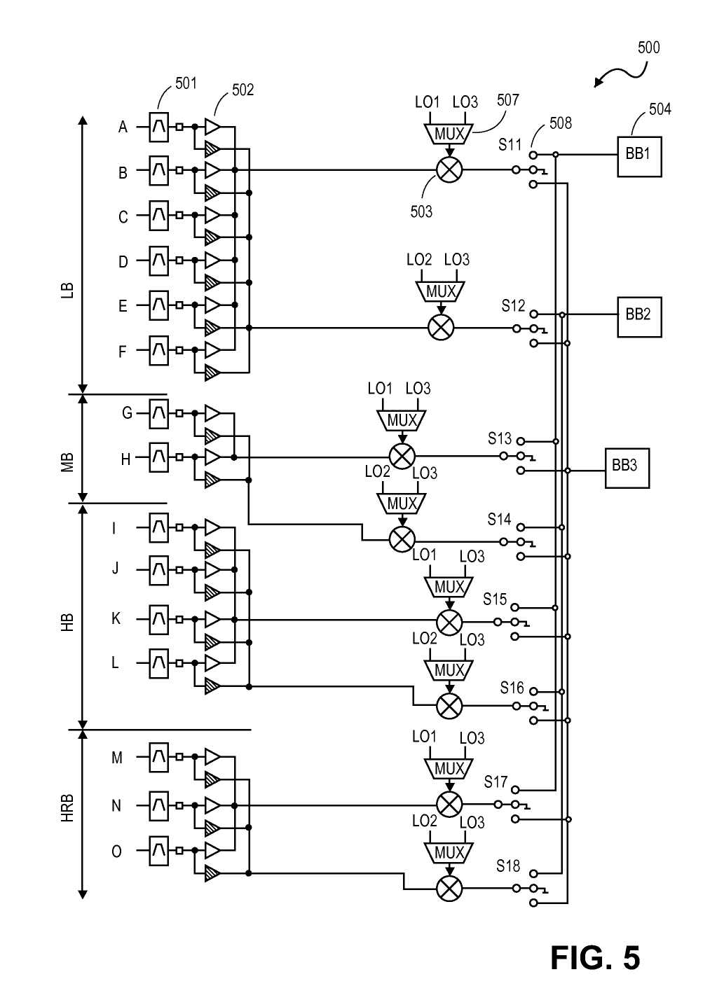

FIG. 5 shows a circuit diagram of an example receiver front-end that processes three component carrier signals that may be received across a number of frequency bands over four frequency band groupings, in which two mixers are used with a respective frequency band grouping for a total of eight mixers. Receiver 500 of FIG. 5 is a variation of receiver 300 of FIG. 3, having similar combination of inputs A-O to filters 501 and LNAs 502. Instead of using two mixers per combined LNA output path per band grouping, only two mixers 503 are used per band grouping for a total of eight mixers. A multiplexer (MUX) 507 is used to select the relevant LO signal to provide which LO provides the LO signal to the mixer in the particular LNA output path. Switches 508 (S11-S18) switches the mixer output path to the relevant BB 504.

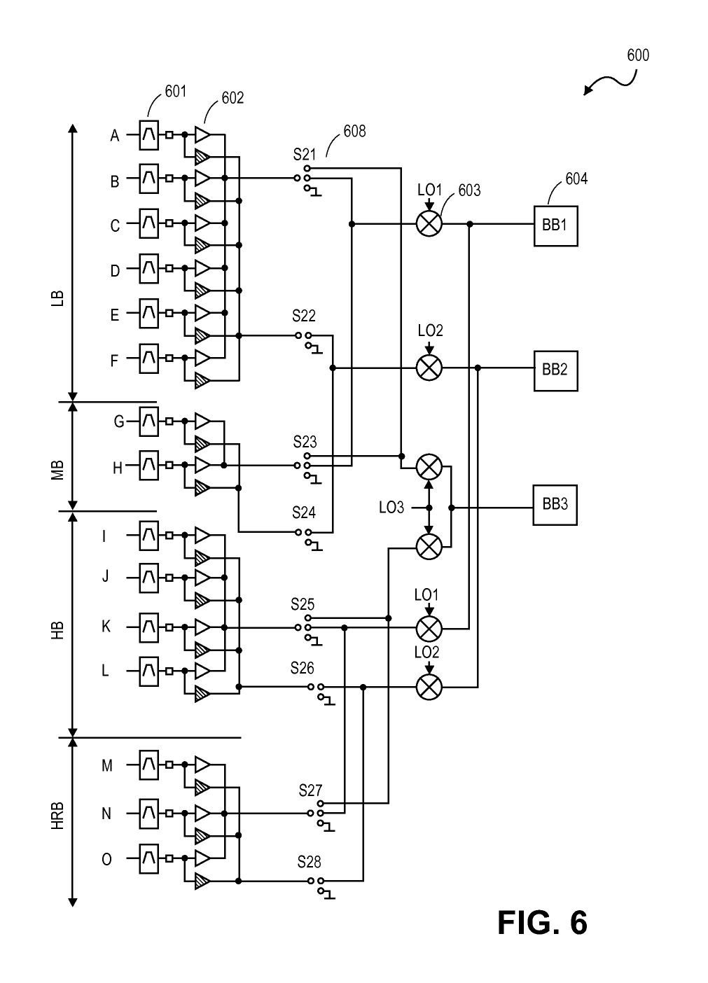

FIG. 6 shows a circuit diagram of an example receiver front-end that processes three component carrier signals that may be received across a number of frequency bands over four band groupings, in which a total of six mixers are used for the four frequency band groupings. Receiver 600 of FIG. 6 is a variation of receiver 300 of FIG. 3, having similar combination of inputs A-O to filters 601 and LNAs 602. Instead of using two mixers for a combined LNA output path per band group (as shown in FIG. 3), receiver 600 uses a total of only six mixers for all of the frequency band groupings. Switches 608 are employed to switch the LNA outputs. One of the combined LNA output path is coupled via switch S21, S23, S25, S27 to one of the two mixers 603, one using LO1 and the other using LO3, while the second of the combined LNA paths is coupled via switch S22, S24, S26, S28 to one mixer that uses LO2. The second LNA path loses the ability to down-convert a component carrier using LO3, but the number of mixers needed is reduced to six. The respective outputs of mixers 603 are sent to respective BBs 604.

With the various embodiments shown in FIGS. 3-6, it is evident that the LNA stage and the BB stage essentially remain the same. Changes are implemented in the mixer stages with varying mixer configurations, as well as the couplings to and from the mixer stages, and the routing and selection of the LO signals to the various mixer stages.

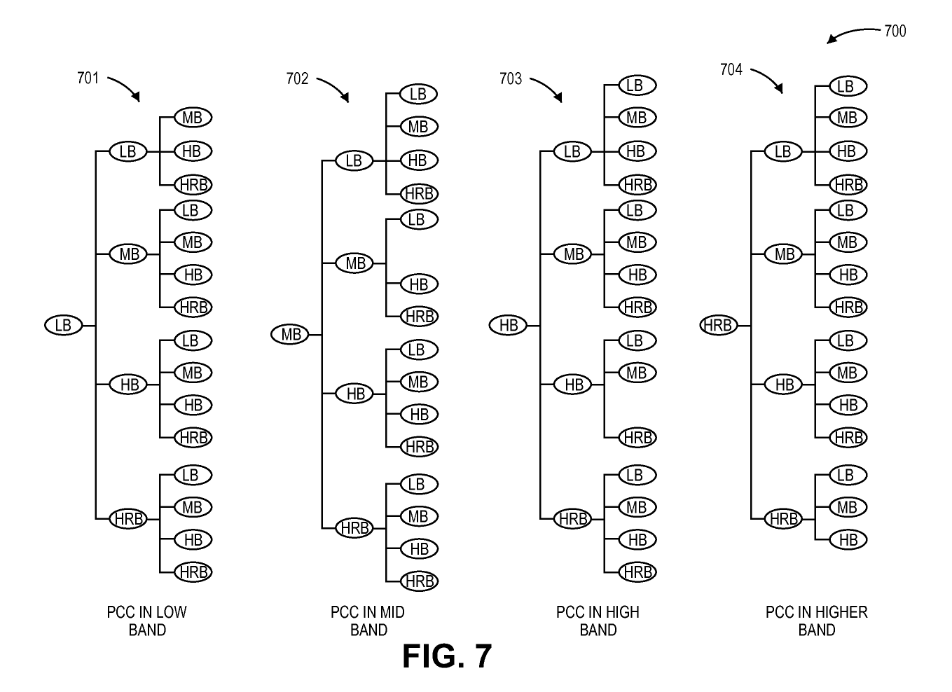

FIG. 7 is an example graph showing primary, secondary and tertiary component carrier processing for the frequency band groupings for the circuits shown in FIGS. 3-6. Diagram 700 illustrates the selection of PCC, SCC and TCC for the embodiment shown in FIGS. 3-6. With the band allocation described above using LB, MB, HB and HRB, the left most diagram 701 shows the instance when the PCC selection is in LB. The adjacent connection shows the selection of SCC, which may be in any one of the band groupings. The subsequent connection shows that TCC may be selected for any band grouping except LB, when the PCC and the SCC are selected to be in the LB.

Likewise, diagram 702 shows that if the PCC and SCC are selected to be both in the MB, then TCC cannot be in the MB as well. Likewise, diagram 703 shows that if the PCC and SCC are selected to be both in the HB, then TCC cannot be in the HB too and diagram 704 shows that if the PCC and SCC are selected to be both in the HRB, then TCC cannot be in the HRB too. Diagram 700 illustrates the flexibility of employing the embodiments described in reference to FIGS. 3-6 to cover various combinations of frequency bands with minimal changes to radio components in front of the LNA stage. The diagram also illustrates that the afore-mentioned condition for the embodiments of FIGS. 3-6 is that a respective frequency band grouping may process only two component carriers due to having only two LNA output paths per band grouping (with the exception that in some instances, two CCA component carriers may be processed as one component carrier). Thus, all three component carriers may be in different frequency band groupings (all inter-band); two component carriers may be in one frequency band grouping, but filtered using different filters, and the third component carrier in a different frequency band grouping (all are inter-band); or two component carriers may be in one frequency band grouping and filtered using the same filter (intra-band), and the third component carrier is in a different frequency band grouping (inter-band).

It is to be noted that the embodiments are not limited to just those illustrated in the disclosure. Although a receiver would add complexity and component count, embodiments may be implemented where more than two LNA output paths are constructed per RF input to a filter. The number of frequency band groupings may be increased as well. Other embodiments may also be readily designed within the framework of the embodiments described above, but taking into account the complexity versus flexibility for a particular application and/or a network in which the device operates, the examples described herein utilizing a plurality of band groupings with two LNA paths per filter input and combining the LNA outputs paths per band grouping for coupling a respective mixer, allows for a less complex and flexible system, while capable of substantially simultaneously processing the aggregation of up to three component carrier signals.

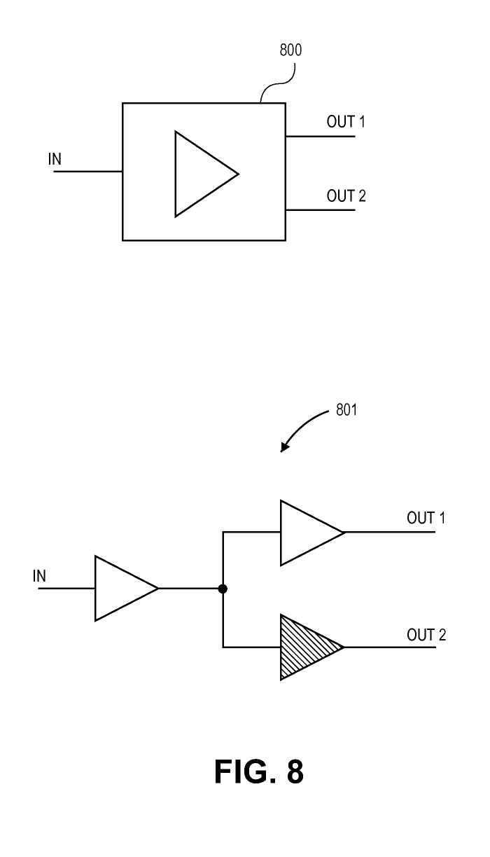

Although a two amplifier structure is shown with the LNAs in FIGS. 3-6, other amplifier configurations may be implemented. FIG. 8 shows two other amplifier configurations to receive an RF input from a filter and provide two output paths. Amplifier 800 is a single amplifier that provides two outputs. For example, an inverted output and a non-inverted output of a single amplifier may be used for the two outputs from a LNA. Likewise, a three amplifier structure 801 may be used, where a first amplifier output is split to inputs of a second and third amplifier. It is to be noted that other configurations are possible.

Thus, a flexible receiver architecture for multiple component carrier aggregation in down link is described. The disclosure pertains to a particular down-link LTE or 4G standard, but is not limited to such down-link transmission. With the embodiments described herein, a device manufacture may use present devices (or with slight modification) that received a single carrier to now receiving multiple component carriers, by replacing only the RFIC chip. Since the design of the RFIC takes into account the front-end components, the device manufacturer may retain the current device front-end. Only the back end for processing the new RFIC chip would be modified or replaced. Furthermore, the embodiments described provide for a flexible scheme in processing up to three component carrier signals. However, other embodiments may be readily implemented to process and aggregate more than three component carrier signals.

As may be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level.

As may also be used herein, the terms “processing module”, “processing circuit”, “processor”, “processing unit”, “baseband processor”, “signal processor” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions.

The term “module”, “assembly”, or “stage” is used in the description of one or more of the embodiments. Such terms may be applicable to a circuit, part of a circuit or grouping of circuits that provide a particular function.

The one or more embodiments are used herein to illustrate one or more aspects, one or more features, one or more concepts, and/or one or more examples that may be implemented. While particular combinations of various functions and features of the one or more embodiments have been expressly described herein, other combinations of these features and functions are likewise possible. The disclosure is not limited by the particular examples disclosed herein and expressly incorporates other combinations as well.

What is claimed is:

1. A method of processing a wireless communication signal having a plurality of component carriers comprising:
receiving a plurality of component carrier signals of a wireless communication signal transmitted from one or more transmitting source;
utilizing a plurality of filters at a receiver front-end to filter the wireless communication signal into separate input paths, in which the filters are configured to provide filtering that correspond to frequency bands and in which the filters are also grouped into a plurality of filter groupings to provide for respective frequency band groupings, wherein the component carrier signals are filtered into one or more of the separate input paths of the receiver based on carrier frequencies of the component carrier signals;
utilizing a plurality of amplifiers to amplify respective filtered component carrier signals, in which respective input paths are separated into a plurality of amplifier paths that include at least a first amplifier path and a second amplifier path, wherein first outputs of the amplifiers of the first amplifier path for the respective frequency band groupings are configured for input into a respective first mixer stage and second outputs of the amplifiers of the second amplifier path for the respective frequency band groupings are configured for input into a respective second mixer stage;
utilizing a first of a plurality of local oscillator signals to down-convert in a corresponding first mixer stage, a first filtered component carrier signal present at one of the first outputs of the first amplifier path; and
utilizing a second of the plurality of local oscillator signals to down-convert in a corresponding second mixer stage, a second filtered component carrier signal present at one of the second outputs of the second amplifier path, in order to down-convert the first filtered component carrier signal and to down-convert the second filtered component carrier signal to aggregate the plurality of component carrier signals.

2. The method of claim 1, wherein the first filtered component carrier signal and the second filtered component carrier signal are filtered by a same filter for intra-band carrier aggregation.

3. The method of claim 1, wherein the first filtered component carrier signal and the second filtered component carrier signal are filtered by different filters of a same group of the frequency band groupings for inter-band carrier aggregation.

4. The method of claim 1, wherein the first filtered component carrier signal and the second filtered component carrier signal are filtered by different filters of different groups of the frequency band groupings for inter-band carrier aggregation.

5. The method of claim 1, further including using a multiplexer to select the local oscillator signals for the respective mixer stages of the respective frequency band groupings.

6. The method of claim 1, further including a switch configured between the amplifier paths and the mixer stages for the respective frequency band groupings to switch a particular amplifier path to a selected mixer stage.

7. The method of claim 1, further including aggregating three component carrier signals by filtering two of the component carrier signals through a same filter of a first frequency band grouping and filtering a third of the component carrier signals through a different filter in a second frequency band grouping.

8. The method of claim 1, further including aggregating three component carrier signals by filtering two of the component carrier signals respectively through a first filter and a second filter of a first frequency band grouping and filtering a third of the component carrier signals through a third filter in a second frequency band grouping.

9. The method of claim 1, further including aggregating three component carrier signals by filtering the three component carrier signals through different filters of three different groups of the frequency band groupings.

10. The method of claim 1, further including a switch configured between the mixer stages for respective frequency band groupings and baseband processors to switch a particular mixer stage output to a selected baseband processor.

11. A method of processing a wireless communication signal having a plurality of component carriers comprising:
receiving three component carrier signals of a wireless communication signal transmitted from one or more transmitting source, in which the plurality of component carrier signals are used to extend a bandwidth of the wireless communication signal;
utilizing a plurality of filters at a receiver front-end to filter the wireless communication signal into separate input paths, in which the filters are configured to provide filtering that correspond to frequency bands and in which the filters are also grouped into a plurality of filter groupings to provide for respective frequency band groupings, wherein two of the three component carrier signals are filtered by one filter when intra-band filtering and wherein at least two of the three component carrier signals are filtered by different filters when inter-band filtering, based on carrier frequencies of the three component carrier signals;
utilizing a plurality of amplifiers to amplify respective filtered component carrier signals, in which respective input paths are separated into a first amplifier path and a second amplifier path, wherein first outputs of the amplifiers of the first amplifier path for the respective frequency band groupings are configured for input into a respective first mixer stage and second outputs of the amplifiers of the second amplifier path for the respective frequency band groupings are configured for input into a respective second mixer stage;
utilizing a first of a plurality of local oscillator signals to down-convert in a corresponding first mixer stage, a first filtered component carrier signal present at one of the first outputs of the first amplifier path;
utilizing a second of the plurality of local oscillator signals to down-convert in a corresponding second mixer stage, a second filtered component carrier signal present at one of the second outputs of the second amplifier path; and
utilizing a third of the plurality of local oscillator signals to down-convert in a corresponding third mixer stage, a third filtered component carrier signal present at one of the first outputs of the first amplifier path of a different band grouping than the first filtered component carrier signal, wherein the first local oscillator signal for the corresponding first mixer stage, the second local oscillator signal for the corresponding second mixer stage and third local oscillator signal for the corresponding third mixer stage are of different local oscillator frequencies, in order to aggregate the three component carrier signals.

12. The method of claim 11, further including aggregating the three component carrier signals by filtering two of the component carrier signals through a same filter of a first frequency band grouping and filtering a third of the component carrier signals through a different filter in a second frequency band grouping.

13. The method of claim 11, further including aggregating the three component carrier signals by filtering two of the component carrier signals respectively through a first filter and a second filter of a first frequency band grouping and filtering a third of the component carrier signals through a third filter in a second frequency band grouping.

14. The method of claim 11, further including aggregating the three component carrier signals by filtering the three component carrier signals through different filters of three different groups of the frequency band groupings.

15. The method of claim 11, further including using a multiplexer to select the local oscillator signals for the respective mixer stages of the respective frequency band groupings.

16. The method of claim 11, further including a switch configured between the amplifier paths and the mixer stages for the respective frequency band groupings to switch a particular amplifier path to a selected mixer stage.

17. An apparatus to process a wireless communication signal having a plurality of component carriers comprising:
a plurality of amplifiers configured into a grouping of frequency bands and to receive three component carrier signals of a wireless communication signal transmitted from one or more transmitting source, in which the three component carrier signals are used to extend a bandwidth of the wireless communication signal and in which the three component carrier signals have been filtered into separate input paths to the plurality of amplifiers based on frequencies of the component carrier signals, wherein a first amplifier amplifies a first component carrier signal, a second amplifier amplifies a second component carrier signal and a third amplifier amplifies a third component carrier signal;
a plurality of mixers configured with the amplifiers to have a first mixer down-convert a first output signal of the first amplifier having the first component carrier signal based on a first local oscillator signal, a second mixer down-convert a second output signal of the second amplifier having the second component carrier signal based on a second local oscillator signal and a third mixer down-converts a third output signal of the third amplifier having the third component carrier signal based on a third local oscillator signal, wherein at least one of the first, second or third amplifier is configured for receiving a component carrier of a different frequency band grouping allocation, and wherein the first, second and third mixers are configured to use different local oscillator signals based on respective frequencies of the component carrier signals; and
a plurality of baseband processors with a first baseband processor processing a first down-converted output from the first mixer, a second baseband processor processing a second down-converted output from the second mixer and a third baseband processor processing a third down-converted output from the third mixer to baseband process the three down-converted signals to aggregate the three component carrier signals.

18. The apparatus of claim 17, wherein the baseband processors process down-converted component carrier signals for aggregation of the three component carrier signals, in which two of the component carrier signals are filtered by a same filter of a first group of filters and a third of the component carrier signals is filtered by a different filter in a second group of filters, when filters are allocated into a plurality of groups based on frequency bands.

19. The apparatus of claim 17, wherein the baseband processors process down-converted component carrier signals for aggregation of the three component carrier signals, in which two of the component carrier signals are respectively filtered by a first filter and a second filter of a first group of filters and a third of the component carrier signals is filtered by a third filter in a second group of filters, when filters are allocated into a plurality of groups based on frequency bands.

20. The apparatus of claim 17, wherein the baseband processors process down-converted component carrier signals for aggregation of the three component carrier signals, in which the three component carrier signals are filtered by different filters of three different groups of filters, when filters are allocated into a plurality of groups based on frequency bands.
